(19) United States
(12) Patent Application Publication
(10) Pub. No.: US 2003/0025799 A1
(43) Pub. Date: Feb. 6, 2003

(54) Process for improving the view in vehicles

(76) Inventors: Michael Holz, Senden (DE); Edgar Weidel, Senden (DE)

Correspondence Address: Stephan A. Pendorf, Pendorf & Cutliff, P.O. Box 20445, Tampa, FL, 33622-0445, US

(21) Appl. No.: 10/212,316

(22) Filed: Aug. 5, 2002

(30) Foreign Application Priority Data
Aug. 4, 2001 (DE) 101 38 361.4-51

(51) Int. Cl. H04N 5/225

(52) U.S. Cl. 348/207.99

(57) ABSTRACT

Process for improving the view in a vehicle, in particular in darkness, bad weather and fog, wherein laser light with a wavelength outside of the visible spectrum is emitted in a predetermined spatial area, which is observed by a camera, of which the images are displayed to the vehicle operator. According to the invention the laser light and/or the camera is additionally used for optical communication with other vehicles.

### BACKGROUND OF THE INVENTION

1. Field of the Invention

The invention concerns a process for improving the view in a vehicle.

2. Description of the Related Art

For improving the view in vehicles in darkness, bad weather and fog there may be employed an optic-electronic system such as described for example in DE 40 07 646 A1. The system records a video image of a traffic scene and reproduces it for the vehicle operator in an appropriate manner. The represented image contains supplemental information that the vehicle operator could not see with his own eyes or could only see with difficulty, in particular at night, poor weather and fog.

The system contains, besides the normal headlights, an infrared headlight that utilizes near infrared emitting laser diodes as a light source. The laser diodes are driven pulsed. A CCD-camera for recording the video image is housed in roof area of the vehicle. The CCD-camera employs an electronic shutter, which is synchronized with the laser diodes. An optical band pass filter is provided in front of the camera lens. The video image is displayed to the vehicle operator on an LCD-display.

A different type of optic-electronic system for vehicles is a communication system for optical communication between vehicles which are within site of each other.

One such optical communication system for vehicles is known from JP 04241100 A1, wherein distance information measured in one vehicle relative to a preceding vehicle is transmitted to a following vehicle via light emitters and receivers. A similar optical communication system for vehicles is known from JP 07044800 A1, wherein the transmitted information is warning information.

From WO 95/04670 an optical communication system for vehicles is known, wherein approaching vehicles automatically exchange information. A similar system is known from EP 0446 161 A1 wherein one light emitter and one light receiver is respectively provided on the front side and the back side of the vehicle in order to facilitate communication towards the front and towards the back.

### SUMMARY OF THE INVENTION

The present invention is concerned with the task of reducing the expense involved in for producing a system for improving the visibility as well as for providing an optical communication system.

The invention is based upon recognition that the laser light source and the camera for the night light system is suitable for carrying out the function of the light emitter and the light receiver of an optical communication system. It is merely necessary to modulate the laser light with the information to be transmitted, and to provide a demodulator for the laser light received by the camera, in order to decode or extract the information contained therein.

If a vehicle is already equipped with a night vision system, it is possible, with very little expense or complexity, to set up an optical communication system which makes possible communication at least in the direction of travel.

If the option of communication in both directions is desired, one could even do this without supplemental light emitters and receivers at the back of the vehicle if one branches or splits off a part of the laser light which is then guided to the rear of the vehicle, for example via light guides such as optical fibers, and the camera is provided with a special lens or optical system which directs light from behind onto an area of the surface of the CCD-element, wherein modulated information contained in the electronic signal supplied to this area can be extracted.

In a preferred embodiment laser light from two or more different types of laser headlights is emitted, which respectively illuminate different parts of the spatial area to be observed. This has the advantage that the type of the laser light source, the light intensity, the optics and in certain cases the wavelength of the respective laser headlights can be optimally adapted to the respective illumination task, for example, for a “street headlight” and a “pedestrian headlight”. By appropriate selection of the parts of the spatial area to be observed, the different types of laser headlights to be used for illumination, and the areas of overlap one can in simple manner optimize the overall emission characteristic.

During this optimization one could also take into consideration the requirements of an optical communication system, which in general only requires one of the multiple headlights or, as the case may be, types of laser headlights.

In a further preferred embodiment the laser light is produced at a location distanced from the front of the vehicle and then communicated to the front of the vehicle by a light guide, where it is emitted using a suitable lens or optical system. This has the advantage, that the sensitive laser light source can be incorporated in a protected location, for example, within the electronics for the night vision system. At the front of the vehicle it is merely necessary to provide the light emission optics, which are more robust. A protected and shatterproof housing of the laser light source is, besides this, also suitable for housing the vehicle communication system.

The use of the light guides has, besides this, the advantage that these can be branched with relative ease, either to provide multiple light emission lenses, including preferably an optical communication system at the backside of the vehicle for communication with following vehicles, with laser light from a common source to supply or for supplying light from multiple light sources, which have different wavelengths, to a common light emission lens.

### DETAILED DESCRIPTION OF THE INVENTION

An automobile includes two or more infrared laser headlights emitting in the direction of travel. Each laser headlight includes one or more infrared lasers, in particular laser diodes which work in the near infrared. Alternatively, the system could also use another spectral realm outside of the visible spectrum, for example, far infrared or ultraviolet light.

If each laser headlight contains only one laser, then different possibilities exist for illuminating the spatial area to be observed:

a) simultaneous illumination of the entire area by two dimensional spreading of the laser beam;

b) spreading only in one direction with simultaneous narrow bundling in the orthogonal second direction and pivoting (scanning) the emitted flat space angle segment in the second direction; and

c) pivoting the entire laser beam in two dimensions for scanning illumination of the entire spatial area.

Besides this, there is the possibility of employing an array of laser diodes which cooperate to illuminate the entire spatial area as laser headlights.

In the illustrative embodiment, two different types of laser headlights are employed, which respectively illuminate different portions of the spatial area to be observed. A first type of laser headlight, either an individual headlight or possibility also multiple—for example, two laser headlights, which respectively are provided in the vicinity of the conventional headlight—illuminate the street ahead of the vehicle in the manner similar to a conventional headlight, that is, a relatively narrow segment of the spatial area to be observed. A second type of laser headlight, likewise either a single headlight or multiple, for example, twin laser headlights, which are respectively provided in the vicinity of the conventional headlight, illuminate the spatial area being observed concentrated in an area near to the vehicle, that is, diagonally downwards and outwards from the vehicle, as well as, preferably asymmetrically, diagonally to the side. The second type of laser headlight has an emission characteristic that is similar to the conventional low beam headlight; however, due to the absence of a “blinding” effect for oncoming traffic, can be directed more upwardly, in order to reliably detect persons located in proximity to the edge of the street.

The use of two different types of laser headlights has the advantage, that the laser and the optics of the individual laser headlights can be optimized for the respective purpose of employment. For a “street headlight” it would be sufficient to have an individual laser diode without special optics for beam broadening if the characteristic divergence of that laser diode had the appropriate value for the “distance headlight”. On the other hand, for a “pedestrian headlight” and for the optics thereof for beam broadening, no particular demands must be placed upon the coherency of the laser. Further, the light intensity and possibly also the wavelengths of the two types of laser headlights can be optimally adapted to the respective employment purpose. If two such laser headlights are provided spaced apart from each other, and emit light with different wavelengths which the camera described in greater detail below can distinguish from each other, it is possible to have stereovision using a single camera.

The laser light can, however need not necessarily as in the case in conventional headlights, be generated directly at the front of the vehicle. In one illustrative embodiment one or more laser light sources are housed in the vehicle electronics or in a different protected location, from which the laser light is guided by light guides to one or more light emission lenses, which produce the one or more laser headlights. The light guides may also split or branch, so that for example one laser source can supply multiple laser headlights. Or, one can introduce the light of multiple lasers, which for the above described optimization of illumination can have different wavelengths, by optically coupling light guides to one or more laser headlights.

The automobile further includes a camera as image sensor, which is so arranged, that it records the traffic scene presented in the direction of travel. The camera is sensitive at least to the light of the one or more laser headlights reflected by the environment, which in this illustrative example is in the near infrared. The video image recorded by the camera is displayed to the vehicle operator in a display, using for example a display console in the instrument panel or a projector for reflecting the image in the area of the dashboard in the manner of a heads-up-display.

The camera is preferably mounted directly behind the windshield in the vicinity of the rearview mirror, as described for example in GB 2271139 A1. As described therein, the windshield in this area employs an IR-transmissive material. In the herein described illustrative embodiment a windshield of homogenous material is employed, which is covered with an infrared reflective film for reduction of heat penetration into the vehicle cabin. This film is omitted in the area of the line of sight of the camera, in order to allow transmission of infrared light to the camera, wherein the small IR-absorption in the glass itself is acceptable.

The vertical separation between the laser headlights or the conventional headlight and the laser headlights on the one hand and the camera on the other hand should be as large as possible, so that the camera can see through the reflected light—the atmospheric scatter—of the headlight. In this respect a positioning at the height of the rearview mirror, where today also the rain sensor is provided, is of advantage; the position could however, depending upon the vehicle design, also possibly be further improved in that the camera should always be located as high as possible.

In the above described positioning of the camera behind the windshield one must also take into consideration that the area of the windshield lying in the field of view of the camera may lie in the operating area of a windshield wiper, so that the camera also has unimpeded view even in the case of rain. In the illustrative embodiment the camera and the windshield wiper are operated synchronized with each other in order, for example, in that instant in which the windshield wiper is located in the field of view of the camera, not the actual image, but rather the last transmitted image, is reproduced on the display in the vehicle. The skipped time interval is so short that it is not noticed by the vehicle operator.

If positioning of the camera very high in the vehicle is not desirable or possible for any reason, then the camera could unobtrusively and without impediment by the windshield be housed in one of the external mirrors. If a second camera is provided in the second external mirror, then stereovision, and therewith a distance determination (range finding) of objects is made possible, without requiring a separate distance sensor.

In an alternative embodiment the camera is not sensitive only in the wavelength area of the laser headlight, but rather also in the visible spectrum, as in the case for example in a CCD-sensor, when the otherwise conventional filter for visible light is omitted or made such that it can be deactivated. Thereby the camera can additionally be employed for use in conditions of poor visibility as a daylight camera, in order for example to record images of the actual traffic scenario, on the basis of which an automatic recognition of road borders, traffic scenes or other safety relevant details can be carried out. The recognized details are evaluated as to whether any danger situations are present, for example by departure from the road boundaries or exceeding the safe speed, upon which the vehicle operator is notified by acoustic or optical warning signals.

If the sensitivity of the camera as necessary for IR-night vision is too high for employment as a daylight camera, then it is provided with an automatically adjustable iris, which in daylight is closed to the extent, that the camera is not over-illuminated. There are however also cameras, of which the light sensitivity can be adjusted to the required degree by the use of electronics, such that mechanical devices can be omitted.

In a further embodiment the one or more laser headlights and the camera are not employed only for the above described system for improvement of vision in darkness, bad weather and fog, but rather at the same time in a system for communication with other vehicles, for example, in order to continuously transmit status information, in order to warn operators of preceding or oncoming vehicles of possible dangerous situations or in order to cause vehicles which approach with headlights set on high-beams to automatically dim these to low beams.

For this purpose the laser light actually emitted only for improvement of visibility need merely be modulated with the information to be transmitted, and a vehicle, which likewise has the described camera and/or other IR-sensors and is sensitive in the range of the laser headlight, can extract and evaluate the information from the laser light.

1. Process for improving the view in a vehicle, in particular in darkness, bad weather and fog, wherein laser light with a wavelength outside of the visible spectrum is emitted into a predetermined spatial area, which is observed by a camera, of which the images are displayed to the vehicle operator, thereby characterized, that the laser light and/or the camera is additionally used for optical communication with other vehicles.

2. Process according to claim 1, thereby characterized, that the laser light is modulated with information to be transmitted.

3. Process according to claim 1 or 2, thereby characterized, that the laser light received by the camera is evaluated for information contained therein.

4. Process according to one of the preceding claims, thereby characterized, that the laser light is emitted by at least two different types of laser headlights, which respectively illuminate different portions of the observed spatial area.

5. Process according to one of the preceding claims, thereby characterized, that the laser light is produced at a location remote from the front of the vehicle and is supplied to the front of the vehicle via one or more light guides.

6. Process according to claim 5, thereby characterized, that a portion of the laser light is communicated to the rear of the vehicle.
